(19) United States
(12) Patent Application Publication
(10) Pub. No.: US 2025/0231111 A1
(43) Pub. Date: Jul. 17, 2025

(54) FLUORESCENCE DETECTION DEVICE

(71) Applicants: Japan Display Inc., Tokyo (JP); RIKEN, Wako-shi (JP)

(72) Inventors: Yasuhiro TAKAHASHI, Tokyo (JP); Yasushi TOMIOKA, Tokyo (JP); Rikiya WATANABE, Wako-shi (JP); Jun ANDO, Wako-shi (JP); Hajime SHINODA, Wako-shi (JP)

(73) Assignees: Japan Display Inc., Tokyo (JP); RIKEN, Wako-shi (JP)

(21) Appl. No.: 19/096,998

(22) Filed: Apr. 1, 2025

Related U.S. Application Data
(63) Continuation of application No. PCT/JP2023/036355, filed on Oct. 5, 2023.

(30) Foreign Application Priority Data
Oct. 5, 2022 (JP) 2022-160919

(51) Int. Cl. G01N 21/64; G02F 1/1335

(52) U.S. Cl. CPC G01N 21/645; G02F 1/133531; G02F 1/133543; G01N 2021/6471; G01N 2201/0683

(57) ABSTRACT

According to an aspect, a fluorescence detection device includes: a light source configured to irradiate a sample with excitation light in a circularly polarized state; a sample holder configured to hold the sample; a cholesteric liquid crystal layer configured to transmit fluorescence emitted by the sample due to the excitation light and reflect the excitation light; and a sensor configured to detect the fluorescence transmitted through the cholesteric liquid crystal layer.

### CROSS-REFERENCE TO RELATED APPLICATIONS

This application is a continuation of International Patent Application No. PCT/JP2023/036355 filed on Oct. 5, 2023, which claims the benefit of priority from Japanese Patent Application No. 2022-160919 filed on Oct. 5, 2022, the entire contents of each are incorporated herein by reference.

### BACKGROUND

### 1. Technical Field

What is disclosed herein relates to a fluorescence detection device.

### 2. Description of the Related Art

The technology described in Japanese Patent Application Laid-open Publication No. 2005-321753 (JP-A-2005-321753) includes an optical system with a dichroic mirror and detects fluorescence reflected from a sample. The technology described in Japanese Patent Application Laid-open Publication No. 2005-187316 (JP-A-2005-187316) provides a substrate that allows a very small amount of specific substance to densely and reproducibly adhere to and be held in a minute region.

It has been required that dichroic mirrors are eliminated in the technology described in JP-A-2005-321753 and higher performance is achieved in removing excitation light in recesses for holding a liquid sample on the substrate surface in the technology described in JP-A-2005-187316.

For the foregoing reasons, there is a need for a fluorescence detection device that has higher detection sensitivity for fluorescence.

### SUMMARY

According to an aspect, a fluorescence detection device includes: a light source configured to irradiate a sample with excitation light in a circularly polarized state; a sample holder configured to hold the sample; a cholesteric liquid crystal layer configured to transmit fluorescence emitted by the sample due to the excitation light and reflect the excitation light; and a sensor configured to detect the fluorescence transmitted through the cholesteric liquid crystal layer.

### BRIEF DESCRIPTION OF THE DRAWINGS

FIG. 1 is a schematic of a fluorescence detection device according to a first embodiment;

FIG. 2 is a sectional view schematically illustrating a cholesteric liquid crystal layer according to the first embodiment;

FIG. 3 is a plan view schematically illustrating a first layer and a seventh layer of the cholesteric liquid crystal layer according to the first embodiment;

FIG. 4 is a plan view schematically illustrating a second layer of the cholesteric liquid crystal layer according to the first embodiment;

FIG. 5 is a plan view schematically illustrating a third layer of the cholesteric liquid crystal layer according to the first embodiment;

FIG. 6 is a plan view schematically illustrating a fourth layer of the cholesteric liquid crystal layer according to the first embodiment;

FIG. 7 is a plan view schematically illustrating a fifth layer of the cholesteric liquid crystal layer according to the first embodiment;

FIG. 8 is a plan view schematically illustrating a sixth layer of the cholesteric liquid crystal layer according to the first embodiment;

FIG. 9 is a diagram for explaining the relation between excitation light and reflected light;

FIG. 10 is a schematic of an example of the arrangement of through holes;

FIG. 11 is a schematic of the shape of the through hole;

FIG. 12 is a graph of the emission spectrum of an inorganic LED;

FIG. 13 is a schematic of the fluorescence detection device according to a first comparative example;

FIG. 14 is a schematic of the fluorescence detection device according to a second embodiment;

FIG. 15 is a schematic of the fluorescence detection device according to a third embodiment;

FIG. 16 is a schematic of the fluorescence detection device according to a fourth embodiment;

FIG. 17 is a diagram for explaining the wavelength characteristics of reflected excitation light for each number of twisting pitches of liquid crystal molecules;

FIG. 18 is a diagram for explaining the relation between the wavelength characteristics of excitation light reflected when the incident angle to the cholesteric liquid crystal layer is 0° and the wavelength characteristics of excitation light reflected when the incident angle to the cholesteric liquid crystal layer is 30°;

FIG. 19 is a diagram for explaining the relation between the resolution of the cholesteric liquid crystal layer for the excitation light and the incident angle of the excitation light to the cholesteric liquid crystal layer;

FIG. 20 is a diagram for explaining the relation between the reflectance of the excitation light corresponding to the number of twisting pitches when the incident angle to the cholesteric liquid crystal layer is 30° and the reflectance of the excitation light corresponding to the number of twisting pitches when the incident angle to the cholesteric liquid crystal layer is 0°;

FIG. 21 is a schematic of the fluorescence detection device according to a fifth embodiment;

FIG. 22 is a schematic of the fluorescence detection device according to a sixth embodiment;

FIG. 23 is a schematic of the fluorescence detection device according to a seventh embodiment;

FIG. 24 is a schematic of the fluorescence detection device according to a second comparative example;

FIG. 25 is a schematic of the fluorescence detection device according to an eighth embodiment;

FIG. 26 is a schematic of another example of the fluorescence detection device according to the eighth embodiment;

FIG. 27 is a schematic of the fluorescence detection device according to a third comparative example;

FIG. 28 is a schematic of the fluorescence detection device according to a ninth embodiment;

FIG. 29 is a schematic of the fluorescence detection device according to a tenth embodiment;

FIG. 30 is a schematic of another example of the fluorescence detection device according to the tenth embodiment; and

FIG. 31 is a schematic of the fluorescence detection device according to a fourth comparative example.

### DETAILED DESCRIPTION

Exemplary aspects (embodiments) to embody the present disclosure are described below in greater detail with reference to the accompanying drawings. The contents described in the embodiments below are not intended to limit the present disclosure. Components described below include components easily conceivable by those skilled in the art and components substantially identical therewith. Furthermore, the components described below can be appropriately combined. What is disclosed herein is given by way of example only, and appropriate changes made without departing from the spirit of the present disclosure and easily conceivable by those skilled in the art naturally fall within the scope of the disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by the same reference numerals, and detailed explanation thereof may be appropriately omitted.

When the term “on” is used to describe an aspect where a first structure is disposed on or above a second structure in the present specification and the claims, it includes both of the following cases unless otherwise noted: a case where the first structure is disposed directly on and in contact with the second structure, and a case where the first structure is disposed above the second structure with another structure interposed therebetween.

### First Embodiment

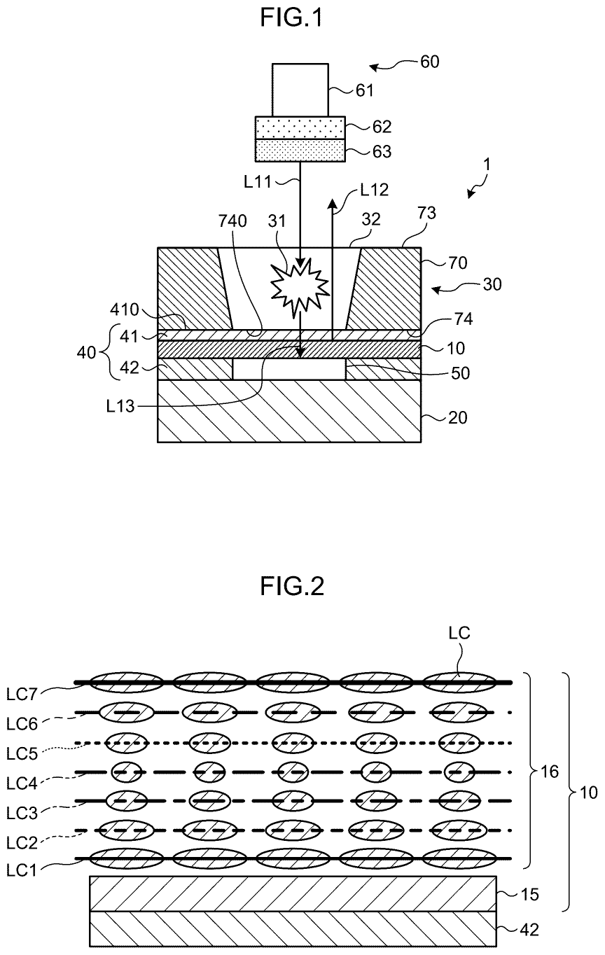

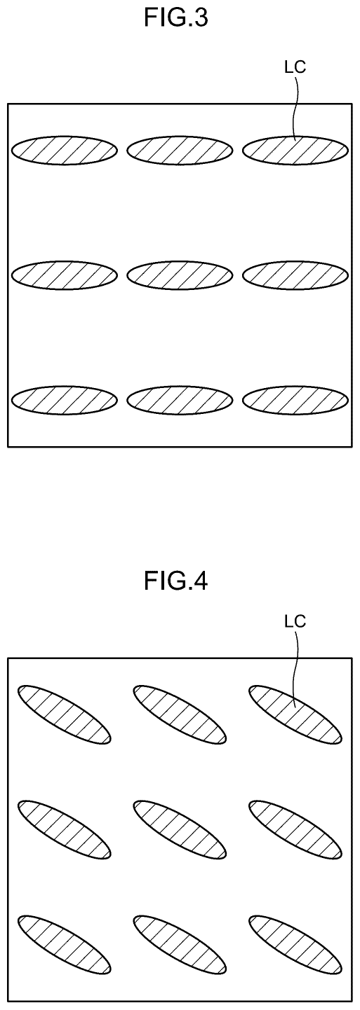

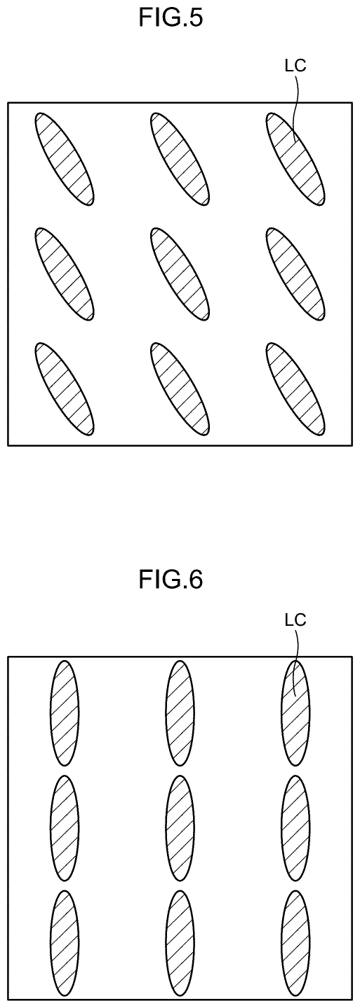

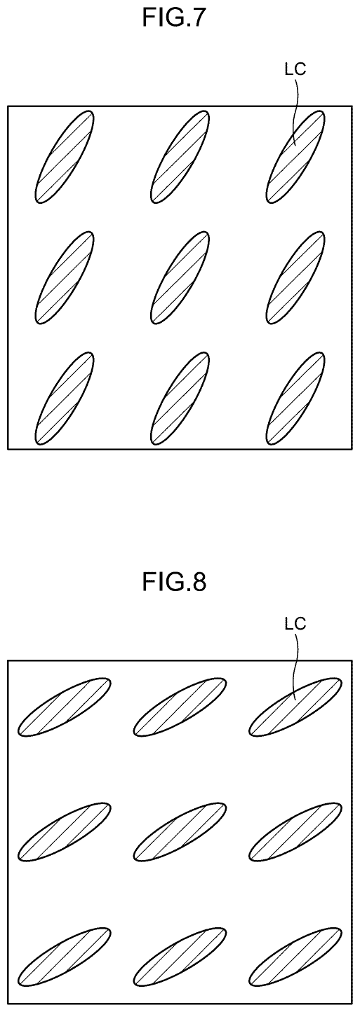

FIG. 1 is a schematic of a fluorescence detection device according to a first embodiment. FIG. 2 is a sectional view schematically illustrating a cholesteric liquid crystal layer according to the first embodiment. FIG. 3 is a plan view schematically illustrating a first layer and a seventh layer of the cholesteric liquid crystal layer according to the first embodiment. FIG. 4 is a plan view schematically illustrating a second layer of the cholesteric liquid crystal layer according to the first embodiment. FIG. 5 is a plan view schematically illustrating a third layer of the cholesteric liquid crystal layer according to the first embodiment. FIG. 6 is a plan view schematically illustrating a fourth layer of the cholesteric liquid crystal layer according to the first embodiment. FIG. 7 is a plan view schematically illustrating a fifth layer of the cholesteric liquid crystal layer according to the first embodiment. FIG. 8 is a plan view schematically illustrating a sixth layer of the cholesteric liquid crystal layer according to the first embodiment. As illustrated in FIG. 1, a fluorescence detection device 1 includes a light source 60, a cholesteric liquid crystal layer 10, a light-transmitting substrate 20, a sample holder 30, a resin layer 40, and a sensor 50 in a space shielded from light from the outside.

When the fluorescence detection device 1 irradiates a sample 31 with excitation light L11 of a predetermined wavelength, the substance in the sample 31 is excited and emits fluorescence L13 having spectral characteristics the peak wavelength of which slightly deviates from the wavelength of the excitation light. The fluorescence detection device 1 enables observing the intensity of the fluorescence L13 and the emission intensity distribution of the fluorescence L13.

The resin layer 40 is made of light-transmitting optical resin and includes a first resin layer 41 and a second resin layer 42. The first resin layer 41 is disposed on the upper side of the cholesteric liquid crystal layer 10. The second resin layer 42 is disposed on the lower side of the cholesteric liquid crystal layer 10. The resin layer 40 is formed integrally with the cholesteric liquid crystal layer 10.

The light-transmitting substrate 20 is an insulating base and is made of glass, for example. The light-transmitting substrate 20 is disposed on the lower side of the second resin layer 42.

In the cholesteric liquid crystal layer 10, a liquid crystal layer 16 is formed on the second resin layer 42 with an orientation film 15 interposed therebetween. The orientation film 15 is made of polyimide or the like and is provided by being subjected to rubbing or photo-orientation treatment. In a cholesteric liquid crystal, elongated liquid crystal molecules are arranged with their long axes aligned in one plane, and liquid crystal molecules LC helically rotate about an axis along a direction perpendicular to the plane of the second resin layer 42. Specifically, in a first layer LC1, a second layer LC2, a third layer LC3, a fourth layer LC4, a fifth layer LC5, a sixth layer LC6, and a seventh layer LC7 illustrated in FIG. 2, the liquid crystal molecules LC rotate as illustrated in FIGS. 3 to 8. The long axes of the liquid crystal molecules LC are aligned every ½ of a pitch p of the helix. Therefore, the long axis of the liquid crystal molecules LC in the first layer LC1 is aligned with the long axis of the liquid crystal molecules LC in the seventh layer LC7 as illustrated in FIG. 3. The thickness of the cholesteric liquid crystal layer 10 required for the liquid crystal molecules LC to make one full rotation is referred to as the pitch p of the helix.

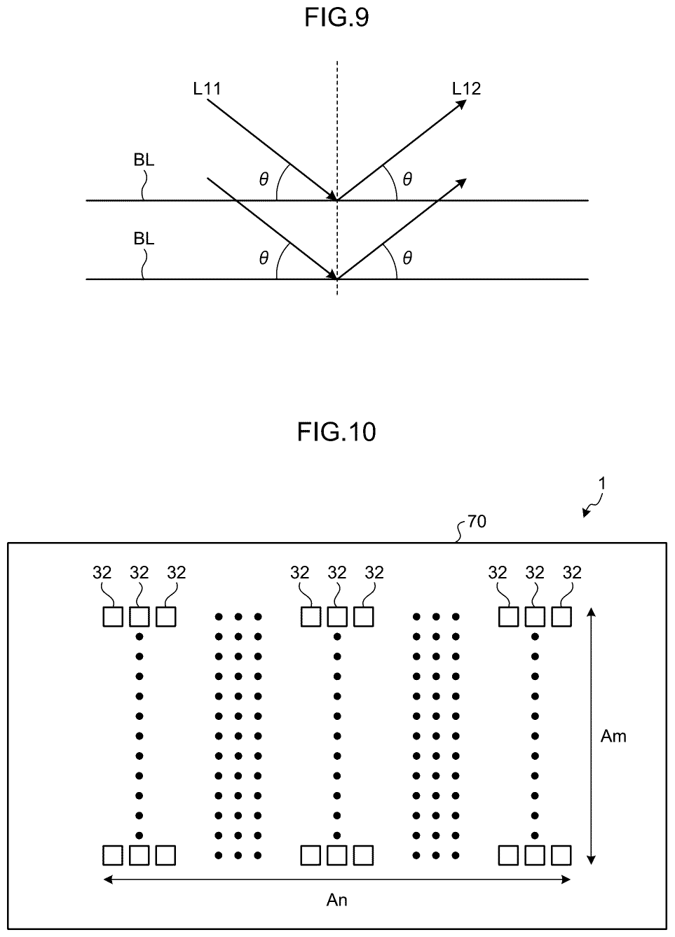

FIG. 9 is a diagram for explaining the relation between excitation light and reflected light. The cholesteric liquid crystal layer 10 reflects light having a predetermined wavelength and circularly polarized in the same rotation direction as that of the helix. As illustrated in FIG. 9, the excitation light L11 incident on the cholesteric liquid crystal layer 10 is reflected according to the same conditions as Bragg's law expressed by the following Expression (1).

2×(p/2)×n×sinθ=m×λ (1)
where m is the reflection order, λ is the reflection wavelength, p is the pitch of the helix, n is the refractive index, and θ is the angle formed by the incident direction of the excitation light with respect to a reflection surface BL.

The sample holder 30 includes a light-shielding resin substrate 70 and has a through hole 32. The resin substrate 70 has a first surface 73 and a second surface 74 opposite to the first surface 73 and positioned closer to the cholesteric liquid crystal layer 10. The through hole 32 passes through the resin substrate 70 from the first surface 73 to the second surface 74. An opening plane 740 of the through hole 32 in the second surface 74 is blocked by an upper surface 410 of the first resin layer 41. The inside of the through hole 32 is filled with an aqueous solution and accommodates the sample 31. The sample holder 30 is positioned on the upper surface 410 of the first resin layer 41 and is formed integrally with the first resin layer 41.

The light source 60 includes a light emitter 61, a polarizing plate 62, and a quarter-wave plate 63. The light emitter 61 is a light-emitting element that oscillates and outputs predetermined excitation light. The polarizing plate 62 makes light from the light emitter 61 linearly polarized. The quarter-wave plate 63 converts light from the polarizing plate 62 into the excitation light L11 in a circularly polarized state.

The sensor 50 is a charge coupled device and serves as an imaging circuit. The sensor 50 is embedded at the center of the second resin layer 42. The sensor 50 can detect the intensity of fluorescence and the emission intensity distribution of fluorescence.

As illustrated in FIG. 9, the excitation light L11 incident from the light source 60 is selectively reflected according to Bragg's law as reflected light L12. For example, if a plurality of liquid crystal molecules rotate clockwise, the cholesteric liquid crystal layer 10 reflects, as the reflected light L12, light in a right-handed circularly polarized state having a wavelength corresponding to the pitch p out of the excitation light L11. By contrast, if a plurality of liquid crystal molecules rotate counterclockwise, the cholesteric liquid crystal layer 10 reflects, as the reflected light L12, light in a left-handed circularly polarized state having a wavelength corresponding to the pitch p out of the excitation light L11.

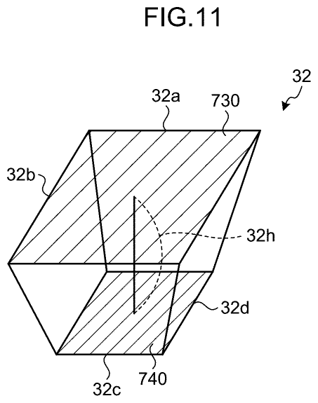

FIG. 10 is a schematic of an example of the arrangement of the through holes. FIG. 11 is a schematic of the shape of the through hole. As illustrated in FIG. 10, a plurality of through holes 32 are formed in one resin substrate 70. For example, 25 through holes 32 arranged in a vertical direction Am and 50 through holes 32 arranged in a horizontal direction An, that is, a total of 1,250 through holes 32 are formed at equal intervals in one resin substrate 70. As illustrated in FIG. 11, an opening plane 730 of the through hole 32 in the first surface 73 has a square shape with one side 32a having a length of 650 μm and the other side 32b having a length of 650 μm, for example. The opening plane 740 of the through hole 32 in the second surface 74 has a square shape with one side 32c having a length of 350 μm and the other side 32d having a length of 350 μm, for example. A depth 32h of the through hole 32 is 150 μm, for example.

The cholesteric liquid crystal layer 10 is produced by selecting a liquid crystal material and a chiral agent corresponding to the wavelength of the excitation light L11.

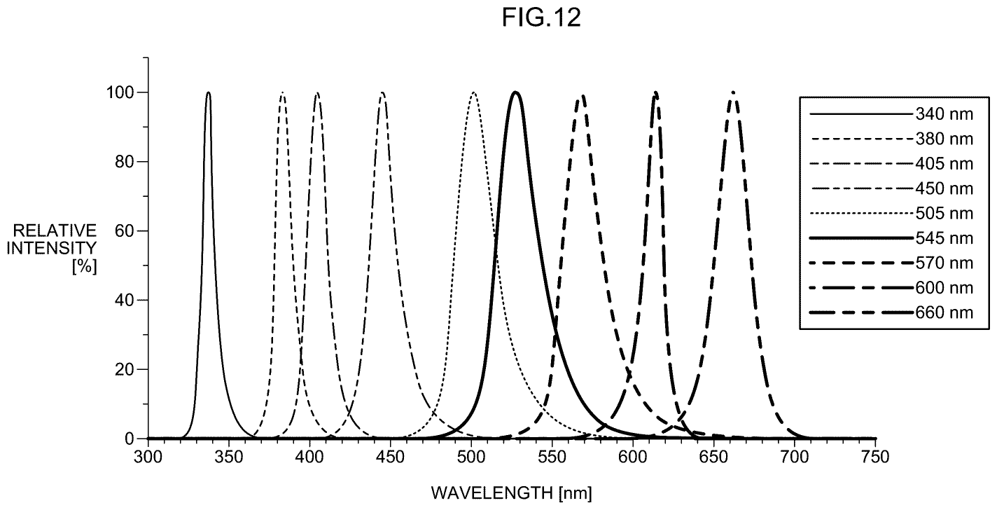

FIG. 12 is a graph of the emission spectrum of an inorganic LED. As illustrated in FIG. 12, if the light source 60 is an inorganic light-emitting diode (LED), for example, the wavelength range is approximately 100 nm. Therefore, the wavelength range of light reflected by the cholesteric liquid crystal layer 10 needs to be at least 50 nm or larger.

The wavelength range of light reflected by the cholesteric liquid crystal layer 10 is preferably 100 nm or larger.

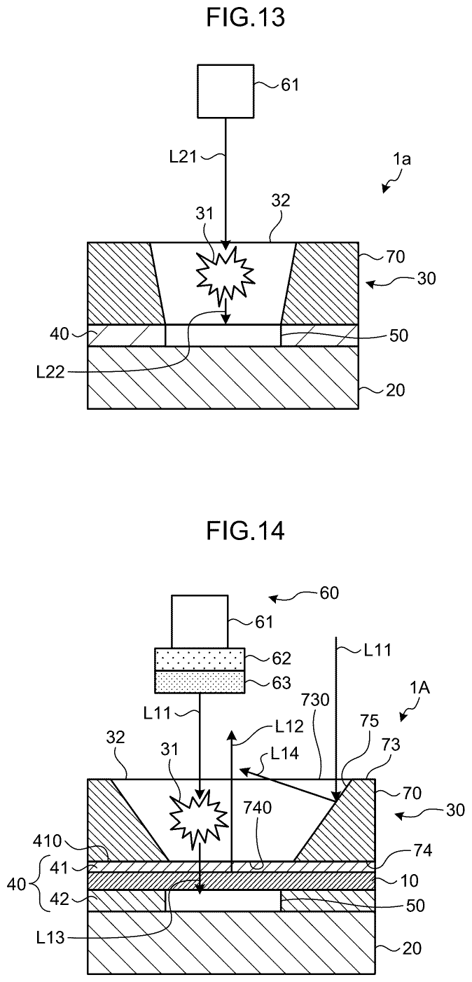

FIG. 13 is a schematic of the fluorescence detection device according to a first comparative example. A fluorescence detection device 1a according to the first comparative example illustrated in FIG. 13 does not include the cholesteric liquid crystal layer 10, compared with the fluorescence detection device 1 illustrated in FIG. 1.

When the fluorescence detection device 1a according to the first comparative example irradiates the sample 31 with excitation light L21 of a predetermined wavelength, the substance in the sample is excited and emits fluorescence having spectral characteristics the peak wavelength of which slightly deviates from the wavelength of the excitation light. In the fluorescence detection device 1a, fluorescence L22 containing noise of the excitation light reaches the sensor 50.

By contrast, in the fluorescence detection device 1 according to the first embodiment, the cholesteric liquid crystal layer 10 selectively reflects the excitation light L11 as the reflected light L12.

As described above, the fluorescence detection device 1 according to the first embodiment includes the light source 60, the cholesteric liquid crystal layer 10, and the sensor 50. The light source 60 irradiates the sample 31 with the excitation light L11 in a circularly polarized state. The cholesteric liquid crystal layer 10 transmits the fluorescence L13 emitted by the sample 31 due to the excitation light L11 and reflects the excitation light L11. The sensor 50 detects the fluorescence L13 transmitted through the cholesteric liquid crystal layer 10. Therefore, the excitation light L11 can be selectively reflected as the reflected light L12, and the excitation light L11 that reaches the sensor 50 is reduced. As a result, the detection sensitivity for the fluorescence L13 detected by the sensor 50 is improved.

### Second Embodiment

FIG. 14 is a schematic of the fluorescence detection device according to a second embodiment. In the following description, the same components as those described in the embodiment above are denoted by the same reference numerals, and duplicated explanation is omitted.

A fluorescence detection device 1A includes the light source 60, the cholesteric liquid crystal layer 10, the light-transmitting substrate 20, the sample holder 30, the resin layer 40, and the sensor 50 in a space shielded from light from the outside.

Assume that the angle between the second surface 74 and a side wall 75 of the through hole 32 is 45° or larger.

If the excitation light L11 from the light source 60 is refracted by the side wall 75, the direction of the circular polarization state of the reflected light L12 is reversed, and the reflected light L12 is likely to be incident on the sensor 50. The direction in which the liquid crystal molecules LC of the cholesteric liquid crystal layer 10 rotate is opposite to the direction of the circular polarization state of the reflected light L12. As a result, the cholesteric liquid crystal layer 10 fails to reflect the reflected light L12, and the fluorescence L22 containing noise of the excitation light L11 may possibly reach the sensor 50.

To address this, as illustrated in FIG. 14, the through hole 32 is tapered such that the area of the opening plane 730 is larger than the opening area of the opening plane 740, and the angle between the second surface 74 and the side wall 75 is 45° or smaller.

With this configuration, the fluorescence detection device 1A can reflect the excitation light L11 as reflected light L14 and make it difficult for the excitation light L11 to be incident on the sensor 50.

### Third Embodiment

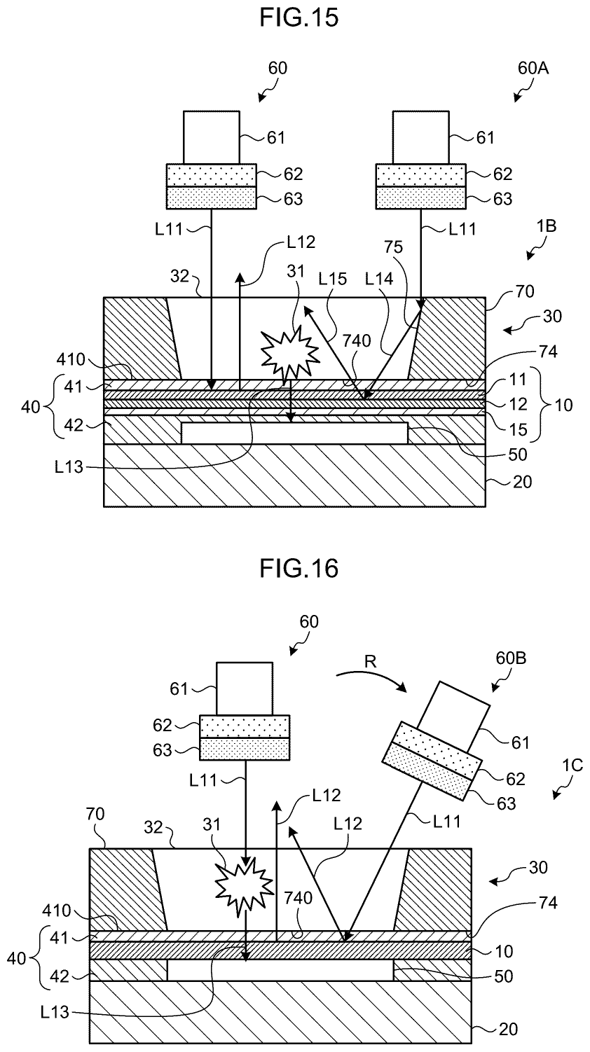

FIG. 15 is a schematic of the fluorescence detection device according to a third embodiment. In the following description, the same components as those described in the embodiments above are denoted by the same reference numerals, and duplicated explanation is omitted.

A fluorescence detection device 1B includes the light source 60, the cholesteric liquid crystal layer 10, the light-transmitting substrate 20, the sample holder 30, the resin layer 40, and the sensor 50 in a space shielded from light from the outside. Specifically, the cholesteric liquid crystal layer 10 according to the third embodiment has the liquid crystal molecules LC that helically rotate, and includes a first liquid crystal layer 11 and a second liquid crystal layer 12. The second liquid crystal layer 12 has the liquid crystal molecules LC that rotate in a direction different from the direction in which the liquid crystal molecules LC of the first liquid crystal layer 11 rotate. The first liquid crystal layer 11 includes the liquid crystal molecules LC that rotate counterclockwise, and is formed on the second liquid crystal layer 12. The second liquid crystal layer 12 includes the liquid crystal molecules LC that rotate clockwise, and is formed on the orientation film 15. The cholesteric liquid crystal layer 10 may include three or more liquid crystal layers having the liquid crystal molecules the rotation directions of which are different from each other.

In the fluorescence detection device 1A according to the second embodiment, the angle between the second surface 74 and the side wall 75 is set to 45° or smaller. With this configuration, the fluorescence detection device 1A according to the second embodiment can reflect the excitation light L11 as the reflected light L14 and thus make it difficult for the excitation light L11 to be incident on the sensor 50. By contrast, the fluorescence detection device 1B according to the third embodiment can make it difficult for the reflected light L14 to be incident on the sensor 50 even if the angle between the second surface 74 and the side wall 75 is 45° or larger.

As illustrated in FIG. 15, in the fluorescence detection device 1B according to the third embodiment, the first liquid crystal layer 11 is stacked on the second liquid crystal layer 12, and the second liquid crystal layer 12 includes the liquid crystal molecules LC that rotate in a direction different from the direction in which the liquid crystal molecules LC of the first liquid crystal layer 11 rotate. When the excitation light L11 reaches the first liquid crystal layer 11 from the light source 60 without hitting the side wall 75, the first liquid crystal layer 11 reflects the excitation light L11. As illustrated in FIG. 15, assume that the angle between the second surface 74 and the side wall 75 is 45° or larger. If the excitation light L11 incident from the position of a light source 60A is refracted by the side wall 75, and the reflected light L14 reflected by the side wall 75 is incident on the cholesteric liquid crystal layer 10, the first liquid crystal layer 11 fails to reflect the reflected light L14 from the light source 60A. This is because the direction in which the liquid crystal molecules LC of the first liquid crystal layer 11 rotate is opposite to the direction of the circular polarization state of the reflected light L12.

The reflected light L14 then reaches the second liquid crystal layer 12. The second liquid crystal layer 12 can reflect the reflected light L14 as reflected light L15 because the direction in which the liquid crystal molecules LC of the second liquid crystal layer 12 rotate is the same as the direction of the circular polarization state of the reflected light L12.

### Fourth Embodiment

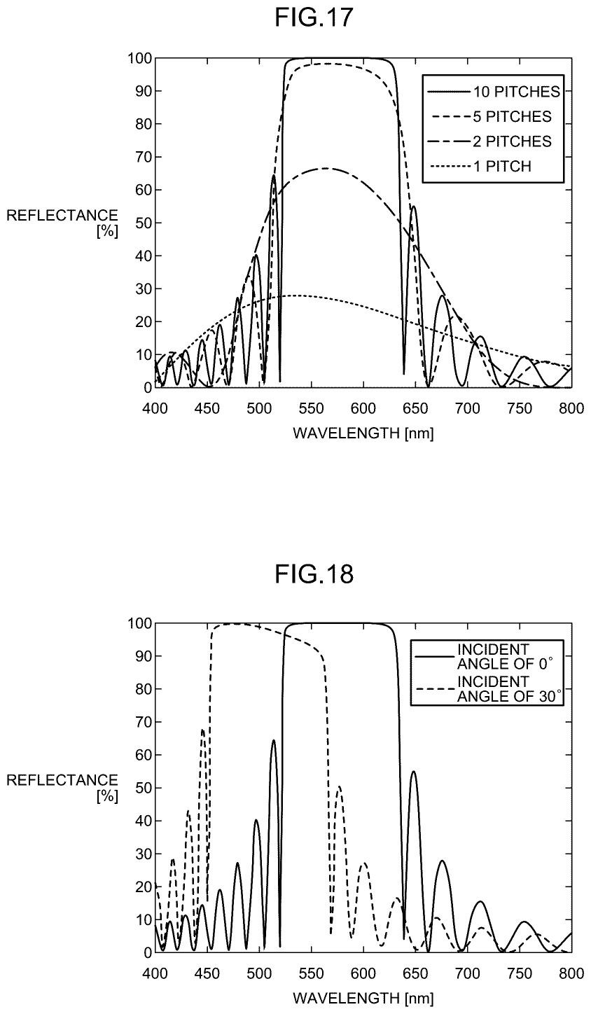

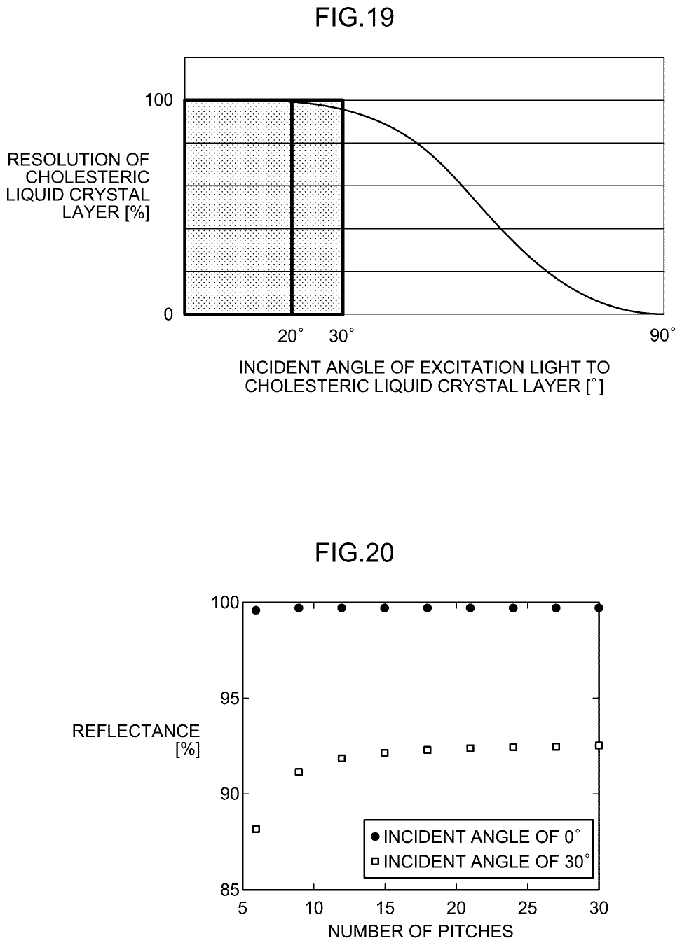

FIG. 16 is a schematic of the fluorescence detection device according to a fourth embodiment. FIG. 17 is a diagram for explaining the wavelength characteristics of the reflected excitation light for each number of twisting pitches of the liquid crystal molecules. FIG. 18 is a diagram for explaining the relation between the wavelength characteristics of the excitation light reflected when the incident angle to the cholesteric liquid crystal layer is 0° and the wavelength characteristics of the excitation light reflected when the incident angle to the cholesteric liquid crystal layer is 30°. FIG. 19 is a diagram for explaining the relation between the resolution of the cholesteric liquid crystal layer for the excitation light and the incident angle of the excitation light to the cholesteric liquid crystal layer. FIG. 20 is a diagram for explaining the relation between the reflectance of the excitation light corresponding to the number of twisting pitches when the incident angle to the cholesteric liquid crystal layer is 30° and the reflectance of the excitation light corresponding to the number of twisting pitches when the incident angle to the cholesteric liquid crystal layer is 0°. In the following description, the same components as those described in the embodiments above are denoted by the same reference numerals, and duplicated explanation is omitted.

A fluorescence detection device 1C includes the light source 60, the cholesteric liquid crystal layer 10, the light-transmitting substrate 20, the sample holder 30, the resin layer 40, and the sensor 50 in a space shielded from light from the outside.

The number of pitches of the helix included in the thickness of the cholesteric liquid crystal layer 10 is referred to as the number of pitches. As illustrated in FIG. 17, the reflectance of the cholesteric liquid crystal layer 10 tends to decrease when the number of pitches is 5 or smaller.

Therefore, to maintain the reflectance of the cholesteric liquid crystal layer 10 at 100% as much as possible, the number of pitches is preferably 5 or larger, and more preferably 10 or larger.

The thickness of the cholesteric liquid crystal layer 10 is preferably 4 μm or 5 μm because the reflectance decreases as the thickness decreases.

As illustrated in FIG. 18, when the angle of incidence of the excitation light L11 with respect to the surface of the cholesteric liquid crystal layer 10 (hereinafter referred to as the incident angle) is 30°, the center wavelength of the cholesteric liquid crystal layer 10 is shifted compared with the case where the incident angle is 0°.

Therefore, if the incident angle is 30° or larger, the fluorescence L22 containing noise of the excitation light L11 may possibly reach the sensor 50.

As illustrated in FIG. 19, the resolution of the cholesteric liquid crystal layer 10 for the excitation light L11 tends to decrease as the incident angle increases.

Therefore, as illustrated in FIG. 16, the fluorescence detection device 1C according to the fourth embodiment can maintain the reflectance for the excitation light L11 and the resolution for the excitation light L11 by setting the incident angle to 30° or smaller, even if the position of the light source 60 is shifted to the position of the light source 60B rotated in a direction R from the position of the light source 60.

To further maintain the resolution for the excitation light L11 and make it difficult for the center wavelength to shift even if the incident angle changes, the incident angle is preferably 30° or smaller. As illustrated in FIG. 19, the resolution can be maintained at 100% when the incident angle is 20° compared with the case where the incident angle is 30°. Therefore, the incident angle is more preferably 20° or smaller.

As illustrated in FIGS. 17 and 20, when the incident angle is 0° and the number of pitches exceeds 5 and is 10 or larger, the reflectance of the cholesteric liquid crystal layer 10 can be maintained at 100% even if the number of pitches increases. Similarly, as illustrated in FIG. 20, when the incident angle is 30° and the number of pitches exceeds 5 and is 10 or larger, the reflectance of the cholesteric liquid crystal layer 10 can be maintained at 93% even if the number of pitches increases. However, as illustrated in FIG. 20, when the incident angle is 30° and the number of pitches is smaller than 10, the reflectance of the cholesteric liquid crystal layer 10 decreases. Therefore, to make it difficult for the reflectance of the cholesteric liquid crystal layer 10 to decrease even if the incident angle changes, the incident angle is preferably 30° or smaller, and the number of pitches is preferably 10 or larger.

The fluorescence detection device 1C reduces the occurrence of the shift of the center wavelength of the cholesteric liquid crystal layer 10 and the decrease in reflectance, thereby increasing the resolution of the cholesteric liquid crystal layer 10 for circularly polarized light.

### Fifth Embodiment

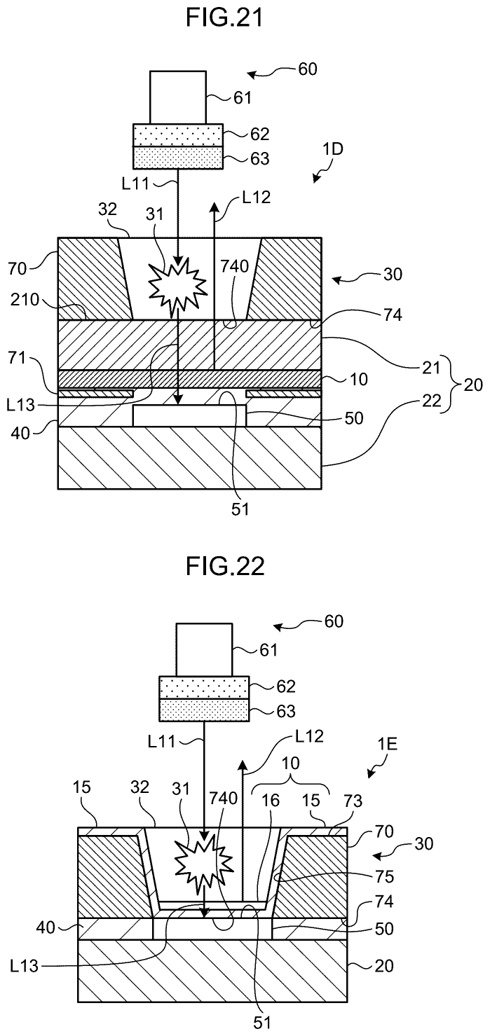

FIG. 21 is a schematic of the fluorescence detection device according to a fifth embodiment. In the following description, the same components as those described in the embodiments above are denoted by the same reference numerals, and duplicated explanation is omitted.

A fluorescence detection device 1D includes the light source 60, the cholesteric liquid crystal layer 10, the light-transmitting substrate 20, the sample holder 30, the resin layer 40, the sensor 50, and a light-shielding layer 71 in a space shielded from light from the outside.

As illustrated in FIG. 21, the light-transmitting substrate 20 includes a first light-transmitting substrate 21 and a second light-transmitting substrate 22. The resin layer 40 is disposed on the second light-transmitting substrate 22. The sensor 50 is embedded at the center of the resin layer 40. The outer periphery of an upper surface 51 of the sensor 50 is surrounded by the light-shielding layer 71. The first light-transmitting substrate 21 is disposed on the cholesteric liquid crystal layer 10.

In the fluorescence detection devices 1, 1A, 1B, and 1C, the sample holder 30 is formed integrally with the first resin layer 41 provided on the cholesteric liquid crystal layer 10, and the opening plane 740 is covered by the upper surface 410 of the first resin layer 41.

By contrast, in the fluorescence detection device 1D, the opening plane 740 is covered by an upper surface 210 of the first light-transmitting substrate 21. The first light-transmitting substrate 21 has higher solvent resistance than resin, thereby increasing the flexibility in selecting the solvent accommodated in the through hole 32.

The light-shielding layer 71 blocks stray light that would be incident on the sensor 50 and reduces light scattering in the first light-transmitting substrate 21, thereby increasing the detection accuracy of the sensor 50.

### Sixth Embodiment

FIG. 22 is a schematic of the fluorescence detection device according to a sixth embodiment. In the following description, the same components as those described in the embodiments above are denoted by the same reference numerals, and duplicated explanation is omitted.

A fluorescence detection device 1E includes the light source 60, the cholesteric liquid crystal layer 10, the light-transmitting substrate 20, the sample holder 30, the resin layer 40, and the sensor 50 in a space shielded from light from the outside.

As illustrated in FIG. 22, the resin layer 40 is disposed on the light-transmitting substrate 20. The sensor 50 is embedded at the center of the resin layer 40. The upper surface 51 of the sensor 50 is exposed and positioned to fit the opening plane 740. The cholesteric liquid crystal layer 10 is disposed on the upper surface 51 of the sensor 50, and the liquid crystal layer 16 is formed on the resin layer 40 with the orientation film 15 interposed therebetween. The orientation film 15 covers the first surface 73 of the sample holder 30, the side wall 75, and the upper surface 51 of the sensor 50.

The fluorescence detection device 1E can be manufactured in a simpler process because the cholesteric liquid crystal layer 10 is formed in the through hole 32.

In the fluorescence detection devices 1, 1A, 1B, and 1C, the excitation light L11 is incident on the cholesteric liquid crystal layer 10 through the first resin layer 41.

By contrast, the fluorescence detection device 1E allows the excitation light L11 to be directly incident on the cholesteric liquid crystal layer 10 without passing through the resin layer. This configuration can further reduce noise of the excitation light L11, thereby increasing the detection accuracy of the sensor 50.

### Seventh Embodiment

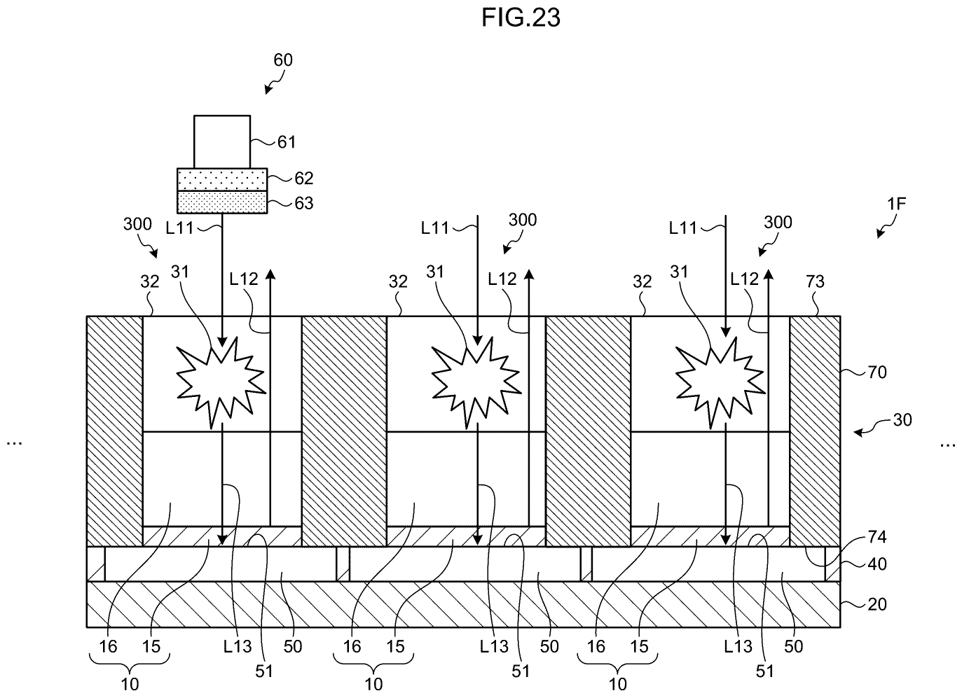

FIG. 23 is a schematic of the fluorescence detection device according to a seventh embodiment. In the following description, the same components as those described in the embodiments above are denoted by the same reference numerals, and duplicated explanation is omitted.

A fluorescence detection device 1F includes the light source 60, the cholesteric liquid crystal layer 10, the light-transmitting substrate 20, the sample holder 30, the resin layer 40, and the sensor 50 in a space shielded from light from the outside.

The sample holder 30 includes the light-shielding resin substrate 70 and has the through hole 32. The resin substrate 70 has the first surface 73 and the second surface 74 opposite to the first surface 73 and positioned on the cholesteric liquid crystal layer 10 side. The through hole 32 passes through the resin substrate 70 from the first surface 73 to the second surface 74.

As illustrated in FIG. 23, a plurality of storage parts 300 each of which accommodates the sample 31 are arranged in one resin substrate 70. Each of the storage parts 300 is surrounded by the side wall 75 of the through hole 32. The storage part 300 is disposed on the cholesteric liquid crystal layer 10. The inside of the storage part 300 is filled with an aqueous solution and accommodates the sample 31.

The resin layer 40 is disposed on the light-transmitting substrate 20. The sensor 50 is embedded at the center of the resin layer 40. The upper surface 51 of the sensor 50 is exposed. A plurality of the sensors 50 are provided for the respective storage parts 300. The cholesteric liquid crystal layer 10 is disposed on the upper surface 51 of the sensor 50, and the liquid crystal layer 16 is formed on the resin layer 40 with the orientation film 15 interposed therebetween. The outer periphery of the cholesteric liquid crystal layer 10 is surrounded by the side wall 75. The sensors 50 are adjacent to each other in a lateral direction.

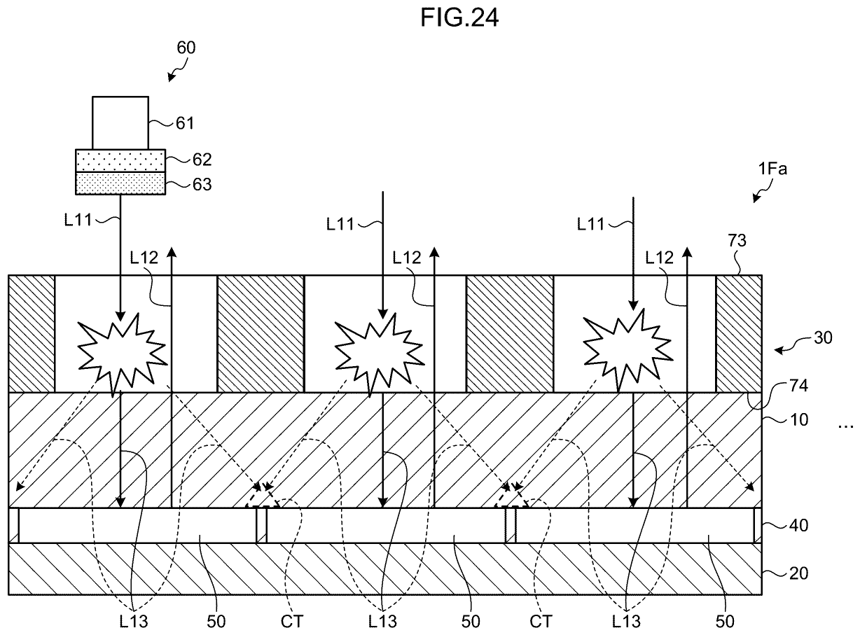

FIG. 24 is a schematic of the fluorescence detection device according to a second comparative example. In a fluorescence detection device 1Fa according to the second comparative example illustrated in FIG. 24, a plurality of cholesteric liquid crystal layers 10 are not provided corresponding to the storage parts 300, and the outer periphery of the cholesteric liquid crystal layer 10 is not surrounded by the resin substrate 70, compared with the fluorescence detection device 1F illustrated in FIG. 23.

To sufficiently reflect the excitation light L11 from the light source 60, the thickness of the cholesteric liquid crystal layer 10 needs to be thicker than that of the storage part 300. In the fluorescence detection device 1Fa according to the second comparative example, however, crosstalk CT occurs in which the fluorescence L13 supposed to enter one sensor 50 of adjacent sensors 50 enters the other sensor 50 thereof, thereby causing mutual interference between the adjacent sensors 50. As a result, the light-receiving sensitivity may possibly decrease.

By contrast, in the fluorescence detection device 1F according to the seventh embodiment, the cholesteric liquid crystal layers 10 are each surrounded by the resin substrate 70 in the respective storage parts 300, and the light is blocked between the cholesteric liquid crystal layers 10. This configuration can reduce the amount of the fluorescence L13 supposed to enter one sensor 50 but entering the other sensor 50.

### Eighth Embodiment

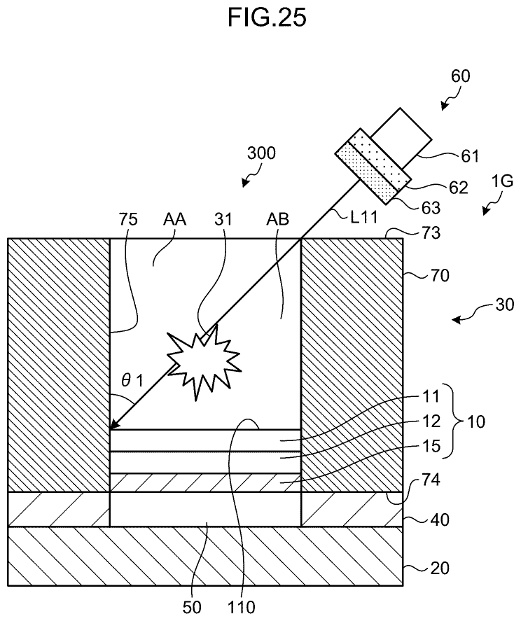

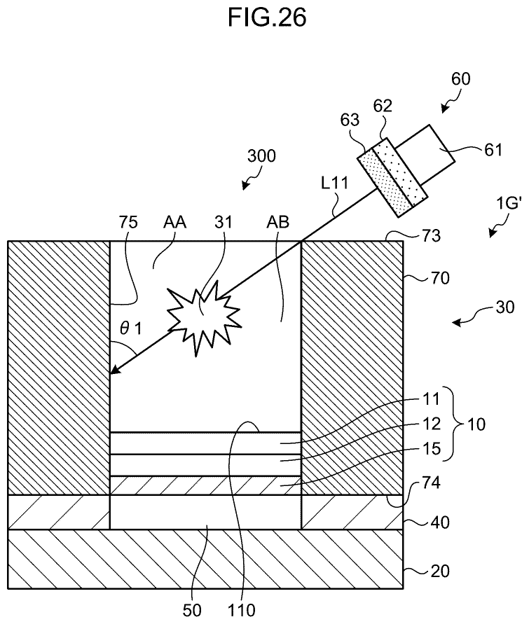

FIG. 25 is a schematic of the fluorescence detection device according to an eighth embodiment. FIG. 26 is a schematic of another example of the fluorescence detection device according to the eighth embodiment. In the following description, the same components as those described in the embodiments above are denoted by the same reference numerals, and duplicated explanation is omitted.

A fluorescence detection device 1G includes the light source 60, the cholesteric liquid crystal layer 10, the light-transmitting substrate 20, the sample holder 30, the resin layer 40, and the sensor 50 in a space shielded from light from the outside. The cholesteric liquid crystal layer 10 includes the first liquid crystal layer 11 and the second liquid crystal layer 12.

As illustrated in FIG. 25, an incident angle θ1 of the excitation light L11 with respect to the side wall 75 is a critical angle of 45° at which the excitation light L11 does not critically or directly enter the sensor 50. As a result, the inside of the storage part 300 is divided into an exposure region AA that is exposed to light and a non-exposure region AB that is not exposed to light. The entire area of an upper surface 110 where the fluorescence L13 is incident on the cholesteric liquid crystal layer 10 faces the non-exposure region AB.

The configuration of a fluorescence detection device 1G′ illustrated in FIG. 26 is the same as that of the fluorescence detection device 1G. As illustrated in FIG. 26, the incident angle θ1 of the excitation light L11 with respect to the side wall 75 is a critical angle of 45° or larger, thereby dividing the inside of the storage part 300 into the exposure region AA and the non-exposure region AB. The entire area of the upper surface 110 where the fluorescence L13 is incident on the cholesteric liquid crystal layer 10 faces the non-exposure region AB.

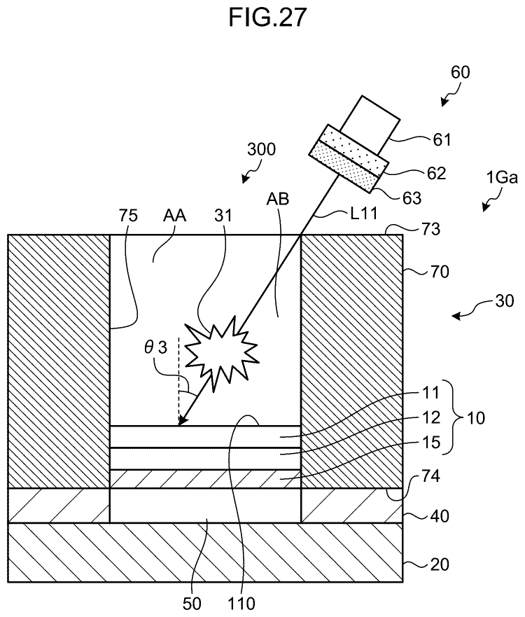

FIG. 27 is a schematic of the fluorescence detection device according to a third comparative example. In a fluorescence detection device 1Ga according to the third comparative example illustrated in FIG. 27, part of the upper surface 110 is exposed to the exposure region AA compared with the fluorescence detection devices 1G and 1G′ illustrated in FIGS. 25 and 26.

In the form of the fluorescence detection device 1Ga according to the third comparative example, the incident angle θ3 of the excitation light L11 with respect to the side wall 75 is smaller than a critical angle of 45°. As a result, part of the upper surface 110 where the fluorescence L13 is incident on the cholesteric liquid crystal layer 10 is exposed to the exposure region AA, and the amount of excitation light L11 that directly enters the sensor 50 increases.

By contrast, in the fluorescence detection devices 1G and 1G′ according to the eighth embodiment illustrated in FIGS. 25 and 26, the entire area of the upper surface 110 faces the exposure region AA, and the excitation light L11 can be incident only on the sample 31. This configuration can make it difficult for the excitation light L11 to directly enter the sensor 50 and thus can reduce the amount of excitation light L11 that enters the sensor 50.

The fluorescence detection device 1G (FIG. 25) and the fluorescence detection device 1G′ (FIG. 26) are examples of a device in which the aspect ratio (length-to-width ratio) between the side wall 75 and the upper surface 110 is 1:1, and the critical incident angle θ1 is 45°. If the aspect ratio (length-to-width ratio) of the fluorescence detection device is different therefrom, the critical incident angle θ1 is appropriately changed depending on the aspect ratio.

For example, when the aspect ratio (length-to-width ratio) of the fluorescence detection device satisfies the size of the side wall 75: the size of the upper surface 110=√3: 1, the critical incident angle θ1 is 30°. By setting the incident angle θ1 to be an angle smaller than a critical angle of 30°, part of the upper surface 110 where the fluorescence L13 is incident on the cholesteric liquid crystal layer 10 is exposed to the exposure region AA, and the amount of excitation light L11 that directly enters the sensor 50 increases.

By contrast, when the incident angle θ1 is a critical angle of 30° or larger, the entire area of the upper surface 110 faces the exposure region AA, and the excitation light L11 can be incident only on the sample 31. This configuration can make it difficult for the excitation light L11 to directly enter the sensor 50 and thus can reduce the amount of excitation light L11 that enters the sensor 50.

### Ninth Embodiment

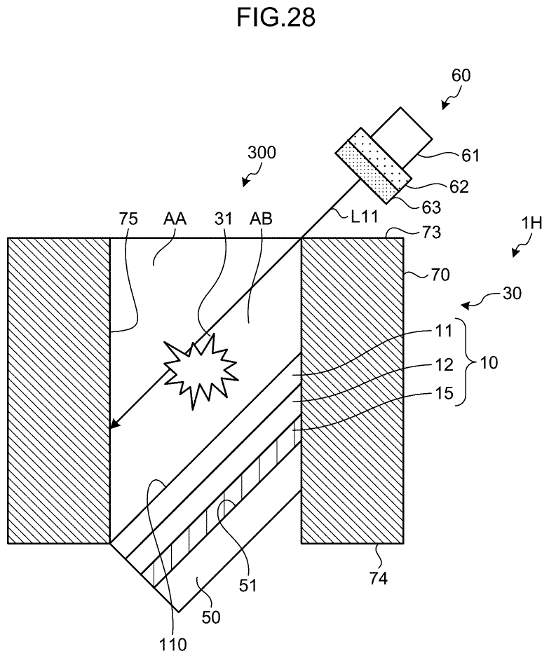

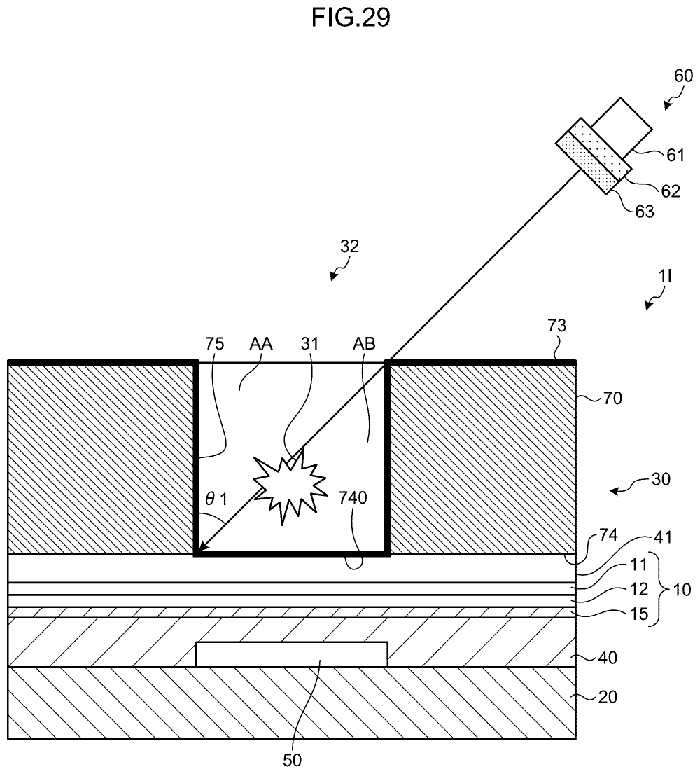

FIG. 28 is a schematic of the fluorescence detection device according to a ninth embodiment. In the following description, the same components as those described in the embodiments above are denoted by the same reference numerals, and duplicated explanation is omitted.

In a fluorescence detection device 1H illustrated in FIG. 28, the upper surface 110 of the cholesteric liquid crystal layer 10 facing the non-exposure region AB and the upper surface 51 of the sensor 50 are inclined with respect to the side wall 75 such that they are parallel to the ray of the excitation light L11.

This configuration increases the distance from the position where the excitation light L11 is reflected by the side wall 75 to the position where the excitation light L11 enters the upper surface 51 of the sensor 50 on which the light is incident. Therefore, the fluorescence detection device 1H can further make it difficult for the excitation light L11 to directly enter the sensor 50 than the fluorescence detection device 1G according to the eighth embodiment does.

### Tenth Embodiment

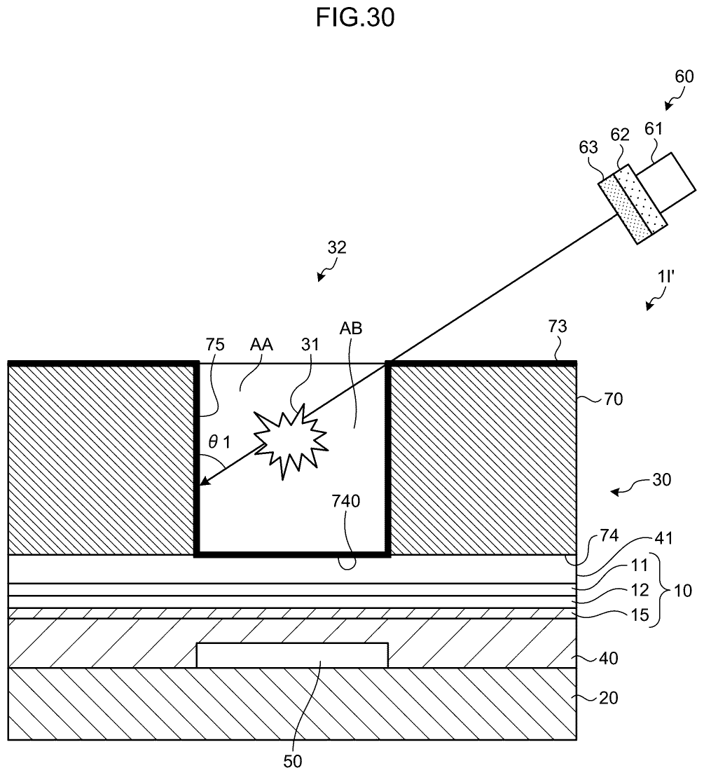

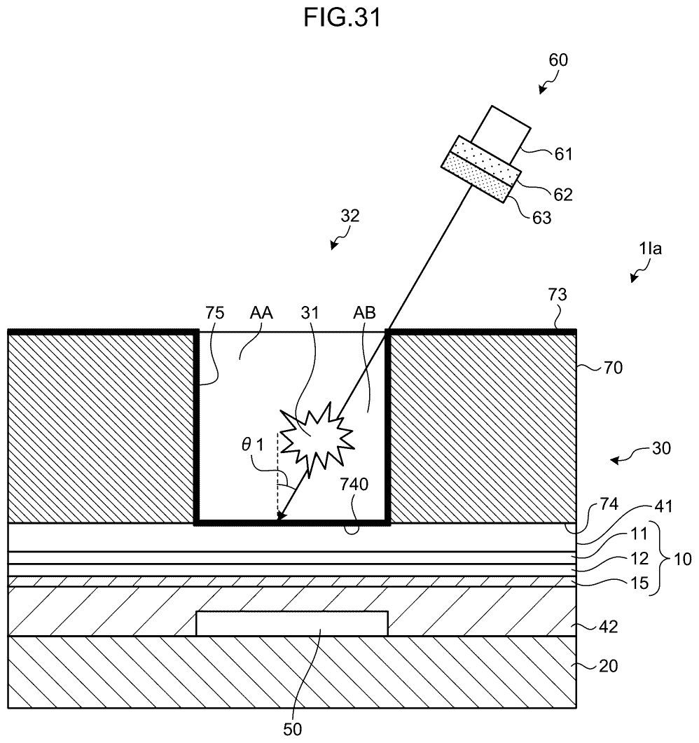

FIG. 29 is a schematic of the fluorescence detection device according to a tenth embodiment. FIG. 30 is a schematic of another example of the fluorescence detection device according to the tenth embodiment. In the following description, the same components as those described in the embodiments above are denoted by the same reference numerals, and duplicated explanation is omitted.

The configuration of a fluorescence detection device 1I illustrated in FIG. 29 and the configuration of the fluorescence detection device 11′ illustrated in FIG. 30 are the same as that of the fluorescence detection device 1B. As illustrated in FIG. 29, the incident angle θ1 of the excitation light L11 with respect to the side wall 75 is a critical angle of 45°, thereby dividing the inside of the through hole 32 into the exposure region AA and the non-exposure region AB. The entire area of the opening plane 740 faces the non-exposure region AB.

In the fluorescence detection device 1I′ illustrated in FIG. 30, the incident angle θ1 of the excitation light L11 with respect to the side wall 75 is a critical angle of 45° or larger, thereby dividing the inside of the through hole 32 into the exposure region AA and the non-exposure region AB. The entire area of the opening plane 740 faces the non-exposure region AB.

FIG. 31 is a schematic of the fluorescence detection device according to a fourth comparative example. In a fluorescence detection device 1Ia according to the fourth comparative example illustrated in FIG. 31, part of the opening plane 740 is exposed to the exposure region AA compared with the fluorescence detection devices 1I and 1I′ illustrated in FIGS. 29 and 30.

In the form of the fluorescence detection device 1Ia according to the fourth comparative example, the incident angle θ1 of the excitation light L11 with respect to the side wall 75 is smaller than a critical angle of 45°. As a result, part of the opening plane 740 is exposed to the exposure region AA, and the amount of excitation light L11 that directly enters the sensor 50 increases.

By contrast, in the fluorescence detection devices 1I and 1I′ according to the tenth embodiment illustrated in FIGS. 29 and 30, the entire area of the opening plane 740 faces the exposure region AA, and the excitation light L11 can be incident only on the sample 31. This configuration can make it difficult for the excitation light L11 to directly enter the sensor 50 and thus can reduce the amount of excitation light L11 that enters the sensor 50.

The fluorescence detection device 1I (FIG. 29) and the fluorescence detection device 1I′ (FIG. 30) are examples of a device in which the aspect ratio (length-to-width ratio) between the side wall 75 and the opening plane 740 is 1:1, and the critical incident angle θ1 is 45°. If the aspect ratio (length-to-width ratio) of the fluorescence detection device is different therefrom, the critical incident angle θ1 is appropriately changed depending on the aspect ratio.

For example, if the aspect ratio (length-to-width ratio) of the fluorescence detection device satisfies the size of the side wall 75: the size of the opening plane 740=√3:1, the critical incident angle θ1 is 30°. By setting the incident angle θ1 to an angle smaller than a critical angle of 30°, part of the opening plane 740 where the fluorescence L13 is incident on the cholesteric liquid crystal layer 10 is exposed to the exposure region AA, and the amount of excitation light L11 that directly enters the sensor 50 increases.

By contrast, when the incident angle θ1 is a critical angle of 30° or larger, the entire area of the opening plane 740 faces the exposure region AA, and the excitation light L11 can be incident only on the sample 31. This configuration can make it difficult for the excitation light L11 to directly enter the sensor 50 and thus can reduce the amount of excitation light L11 that enters the sensor 50.

While exemplary embodiments according to the present disclosure have been described, the embodiments are not intended to limit the disclosure. The contents disclosed in the embodiments are given by way of example only, and various modifications can be made without departing from the spirit of the present disclosure. Appropriate modifications made without departing from the spirit of the present disclosure naturally fall within the technical scope of the disclosure. At least one of various omissions, substitutions, and modifications of the components can be made without departing from the gist of the embodiments and modifications described above.

What is claimed is:

1. A fluorescence detection device comprising:
a light source configured to irradiate a sample with excitation light in a circularly polarized state;
a sample holder configured to hold the sample;
a cholesteric liquid crystal layer configured to transmit fluorescence emitted by the sample due to the excitation light and reflect the excitation light; and
a sensor configured to detect the fluorescence transmitted through the cholesteric liquid crystal layer.

2. The fluorescence detection device according to claim 1, wherein the light source comprises:
a light emitter;
a polarizing plate configured to make light from the light emitter linearly polarized; and
a quarter-wave plate configured to convert the linearly polarized light output from the polarizing plate into the excitation light in the circularly polarized state.

3. The fluorescence detection device according to claim 1, wherein
the sample holder comprises a resin substrate with a light-shielding property having a first surface and a second surface opposite to the first surface and positioned on the cholesteric liquid crystal layer side, and
a through hole passing through the resin substrate from the first surface to the second surface is provided in the sample holder.

4. The fluorescence detection device according to claim 3, wherein
an opening area of the through hole in the first surface is larger than an opening area of the through hole in the second surface, and
an angle between the second surface and a side wall of the through hole surrounding the sample is 45° or smaller.

5. The fluorescence detection device according to claim 3, wherein the cholesteric liquid crystal layer has a liquid crystal molecule that helically rotates, and comprises a first liquid crystal layer and a second liquid crystal layer having the liquid crystal molecule that rotates in a direction different from a direction in which the liquid crystal molecule of the first liquid crystal layer rotates.

6. The fluorescence detection device according to claim 1, wherein an angle of incidence of the excitation light with respect to a surface of the cholesteric liquid crystal layer is 30° or smaller.

7. The fluorescence detection device according to claim 1, further comprising:
a light-transmitting substrate disposed on the cholesteric liquid crystal layer and on which the cholesteric liquid crystal layer is formed; and
a light-shielding layer having a light-shielding property and surrounding an outer periphery of an upper surface of the sensor.

8. The fluorescence detection device according to claim 3, wherein the cholesteric liquid crystal layer is positioned near the second surface in the through hole.

9. The fluorescence detection device according to claim 1, wherein
the sample holder comprises a resin substrate with a light-shielding property having a first surface and a second surface opposite to the first surface,
a through hole passing through the resin substrate from the first surface to the second surface is provided in the sample holder,
a plurality of storage parts each surrounded by a side wall of the through hole and configured to accommodate the sample are provided,
each of the storage parts comprises the cholesteric liquid crystal layer formed on a lower side of the storage part,
a plurality of the sensors are provided for the respective storage parts,
the sensors are each disposed on a lower side of the cholesteric liquid crystal layer,
an outer periphery of the cholesteric liquid crystal layer is surrounded by the side wall, and
the sensors are adjacent to each other in a lateral direction.

10. The fluorescence detection device according to claim 9, wherein
light from the light source is obliquely incident on the side wall,
an inside of the storage part is divided into an exposure region that is exposed to light and a non-exposure region that is not exposed to light, and
an entire area of a surface where the fluorescence is incident on the cholesteric liquid crystal layer faces the non-exposure region.

11. The fluorescence detection device according to claim 10, wherein a surface of the cholesteric liquid crystal layer facing the non-exposure region and an upper surface of the sensor are inclined with respect to the side wall.

12. The fluorescence detection device according to claim 10, wherein
the light from the light source is obliquely incident on the side wall of the through hole,
an inside of the through hole is divided into the exposure region and the non-exposure region, and
an opening plane of the through hole in the second surface faces the non-exposure region.
